(19) United States
(12) Patent Application Publication
(10) Pub. No.: US 2002/0013779 A1
(43) Pub. Date: Jan. 31, 2002

(54) Reverse foreign key techniques in website development

(76) Inventor: Mandayam Andampillai Sridhar, San Jose, CA (US)

Correspondence Address: Joseph A. Nguyen, 3410 Antonacci Ct., San Jose, CA, 95148, US

(21) Appl. No.: 09/764,321

(22) Filed: Jan. 16, 2001

Related U.S. Application Data
(63) Continuation-in-part of application No. 09/531,980, filed on Mar. 20, 2000.

(51) Int. Cl. G06F 7/00

(52) U.S. Cl. 707/4

(57) ABSTRACT

A computer-implemented method for automatically presenting relationship information between a first table and a second table of a database. The method includes ascertaining an existence of a first foreign key relationship between the first table and the second table. If the first foreign key relationship between the first table and the second table exists, automatically generating first executable codes to obtain, for a first given record in the first table, a first number of records in the second table that references the first given record. When the first given record is displayed in a view, the method includes also displaying the first number of records in the second table that references the first given record.

This application is a continuation-in-part of an earlier filed commonly owned patent application entitled “Systems for Developing Websites and Methods Therefor” by inventor M. A. Sridhar, U.S. application Ser. No. 09/531,980, filed on Mar. 20, 2000, which is incorporated herein by reference.

### BACKGROUND OF THE INVENTION

The present invention relates to techniques for developing websites for individuals and businesses. More particularly, the present invention relates to improved techniques for developing websites that are highly decoupled for maintainability and scalability while requiring little programming knowledge on the part of the website developers.

Website development to date has been the province of the sophisticated computer programmers and technologists. A website that includes a front-end user interface, an application layer for performing business or logic operations, and a backend database engine typically requires one or more engineers well versed in programming languages to put together. The bulk of websites today has been built using two approaches: brute force and via some type of application development tool. In the brute force approach, each webpage is hand coded using an appropriate language such as Java, Perl, ASP, TCL, HTML, and the like. The programmer would create codes for interfacing with the user, for performing the required business/logic operation, and for interacting with the backend database. To speed up website development and alleviate some of the more tedious aspects of hand coding, an application development tool may be employed. Application development tools include such integrated development environments as Visual InterDev, PowerBuilder, Designer, and WebDB. However, a substantial amount of programming knowledge and sophisticated technical skills are still required to develop a website using one of the commercially available application development tools.

Under either approach, the high level of technical knowledge required has made it difficult for many to develop their own website. Even when an application development tool is employed, there are significant disadvantages. By way of example, there may be ongoing licensing costs if one of the proprietary application development tool engines is required for website operation and/or maintenance. Furthermore, a given application development tool may require a specific platform to run on, which in turn ties the website owner to a particular platform. Sometimes, a given application development tool may not be compatible with the legacy hardware/software that the business may employ prior to undertaking website development. The platform-specific nature of some application development tool also makes it difficult to enhance and/or scale the website to offer additional features and/or service additional customers. This is because such enhancement or scaling may exceed the capability offered by the application development tool itself. Still further, it is sometimes difficult to maintain websites developed via an application development tool since the proprietary engine may not be accessible for updates and/or changes if features need to be added and/or modified.

### SUMMARY OF THE INVENTION

The invention relates, in one embodiment, to a computer-implemented method for facilitating website development by a website developer from a supplied data schema. The method includes generating a plurality of user data models from the data schema and generating a plurality of data views from the plurality of user data models. The method also includes receiving from the website developer at least one data view choice, the data view choice indicating a selection of a particular data view from the plurality of data views. Additionally, there is included creating backend logic to support the particular data view and creating a user interface front-end to present the particular data view on an output device.

In another embodiment, the invention relates to a computer-implemented method for facilitating website development by a website developer from a supplied data schema. The method includes automatically generating a plurality of user data models from the data schema. The plurality of user data models represents all possible different combinations of user data models from the data schema. The method also includes receiving from the website developer at least one choice that indicates a selection of a particular data view associated with one of the plurality of user data models. Further more, the method includes creating backend logic to support the particular data view and creating a user interface front-end to present the particular data view on an output device.

In yet another embodiment, the invention relates to a computer-implemented method for facilitating website development by a website developer from a supplied data schema. The method includes receiving at least one user data model from the website developer. The user data model pertains to a specific representation of data relationship among data attributes in the data schema. The method includes automatically generating a data view from the user data model, automatically creating backend logic to support the data view, and automatically creating a user interface front-end to present the data view on an output device.

In yet another embodiment, the invention relates to a technique for facilitating website development by a website developer from a supplied data schema. The method includes facilitating the specification of a user data model from the data schema in an accurate and user-friendly manner. The technique includes modeling the data schema using graph theory and extracting from the graph possible relationships pertaining to a particular table to allow the website developer to choose the desired relationship as part of the user data model specification process. The technique also includes automatically extracting the SQL statements from the selected relationship. The graph is also leveraged to support the data integrity requirements of foreign key relationships during the record addition process and to support quality control on the supplied data schema to pinpoint circular reference errors.

In yet another embodiment, the invention relates to a computer-implemented method for automatically presenting relationship information between a first table and a second table of a database. The method includes ascertaining an existence of a first foreign key relationship between the first table and the second table. If the first foreign key relationship between the first table and the second table exists, automatically generating first executable codes to obtain, for a first given record in the first table, a first number of records in the second table that references the first given record. When the first given record is displayed in a view, the method includes also displaying the first number of records in the second table that references the first given record.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in one example, a diagram of a simple data schema that includes three tables in a relational database.

FIG. 2 illustrates a tree representing an automatically generated user data model.

FIG. 3 shows one of the steps in the process of creating a new model.

FIG. 4 illustrates a completed user data model tree in the left pane, with the automatically-generated HTML code in the right pane.

FIG. 5 shows, in accordance with one embodiment, a simplified flowchart illustrating the general steps involved in developing a website

FIG. 6 shows an example of a data schema that involves many interrelated entities.

FIG. 7 shows, in one embodiment, an exemplary user data model that supports a more complex data view than that associated with FIG. 2.

FIG. 8 shows, in accordance with one embodiment, a simplified flowchart illustrating the general steps involved in developing a website having relatively complex data views.

FIG. 9 is a logical depiction of the possible relationships between two tables to facilitate discussion of the use of a graph model in helping the website developer specify the user data model.

FIG. 10 illustrates a simple link table that links to a Supplier table and a Part table for the purpose of illustrating the link table content dereferencing aspect of the present invention.

The steps of the computer-implemented method to dereference the content of a link table are shown in FIG. 11.

FIG. 12 shows an exemplary user data model for the example of FIG. 10.

FIG. 13 shows, in accordance with one embodiment of the present invention, the dereferenced version of link table 1000 of FIG. 10.

FIG. 14 shows, to facilitate discussion of another aspect of the present invention, a Supplier table, a Supplier-Part link table, and a Part table.

FIG. 15 shows, in accordance with one aspect of the present invention, a page view wherein the relationship information is presented in multiple columns.

FIGS. 16A-16D are exemplary tables to facilate discussion of one implementation of the drill-down via foreign key aspect of the present invention.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In accordance with one aspect of the present invention, user data models are automatically created from a furnished data schema. The data schema is generally implemented by tables of a relational database. In one aspect of the present invention, all possible user data models are automatically generated from the furnished data schema. In generating the user data models, links between tables in the data schema are inferred automatically. The user data models are then employed to automatically generate a plurality of data views, which are data output representations of the user data models. These data views may then be provided to the website developer for selection. The website developer may then choose one or more data views to be created. Once a data view is selected, the backend logic is then automatically generated, typically as codes such as SQL, Java, Perl, or TCL codes. The backend logic represents the logic employed to extract data from the database and to manipulate the extracted data to obtain the desired data output. Furthermore, the data view output for the selected data view is automatically generated in a generic webpage, which may then be customized by the website developer to fit the desired data presentation format.

As can be appreciated from the foregoing, website development is substantially simplified in that once the data schema is furnished, the data views are automatically created for selection by the website developer. Selecting the desired data views (e.g., by clicking on selected ones in the list of all possible data views) causes the backend logic and front-end data view output to be automatically generated for each of the selected data views. At this point, all the website developer needs to do is to customize the generic webpages that contain the data view outputs, and website development is substantially done.

In another aspect of the present invention, it is recognized that some relational database may be so voluminous and/or the relationship between tables in such databases may be so complex that the number of possible combinations of user data models may be very large. Even if there is sufficient computing power to generate such large combinations in a reasonable amount of time, it is recognized that the website developer may be overwhelmed with the choices available, making the whole system less than user friendly. In this case, it is preferable that the website developer be furnished with a tool to edit his own user data model in order to more directly specify the data view desired. From the developer-specified user data model, links may be inferred automatically and a data view may be automatically created therefrom. For this data view, the backend logic may also be automatically generated, and the data view output automatically generated as well on a generic webpage. Again, the website developer may modify the generic webpage as necessary to conform the output to the desired data presentation format.

Whether the user data model is automatically generated or specified by the website developer, the present invention simplifies the process of building a website to nonprogramming steps to allow websites to be developed even by people who have only modest technical skills. Furthermore, the process is platform-independent in that the resultant website does not depend on any particular proprietary engine of any application development tool for operation and/or maintenance. This is because the backend logic is preferably generated as platform-independent codes (such as Java, Perl or TCL). The data view output is also generated using platform-independent interfaces such as webpages. Accordingly, scalability, maintainability, and cross-platform compatibility are ensured. The process does not, however, preclude the use of platform-specific technologies such as C/C++ or Microsoft ASP, if such is desired.

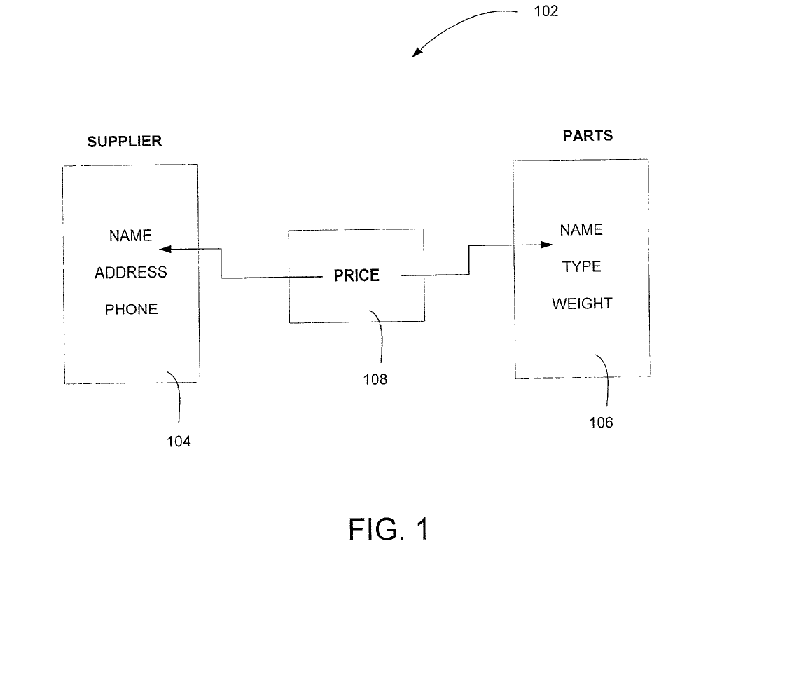

These and other advantages and features of the present invention may be better understood with reference to the figures and discussion below. FIG. 1 shows, in one example, a diagram of a simple data schema 102 that includes three tables in a relational database. In general, a data schema may be thought of as the backend relationship among data tables in a relational database. In the present example, data schema 102 represents a data schema that models the relationship between a supplier and parts for a fictitious purchaser of such parts. As such, a supplier table 104 having attributes such as “name” “address” and “phone” are shown, along with a part table 106, which has attributes such as “name” (for name of the part), type, weight. Of course other attributes are also possible, although only a few are shown here to simplify the discussion.

These two tables 104 and 106 are linked by a link table 108, which may contain, for example, a price attribute. Link table 108 describes the attributes of the relationship between supplier and parts. For example, link table 108 may answer questions such as “I'm interested in knowing the price at which specified suppliers will sell a specific part.” There may also be other link tables that describe other attributes of the relationship between the supplier and the part. For simplicity, other link tables are not shown. The data schema of FIG. 1 is conventional and is familiar to one skilled in the relational database art.

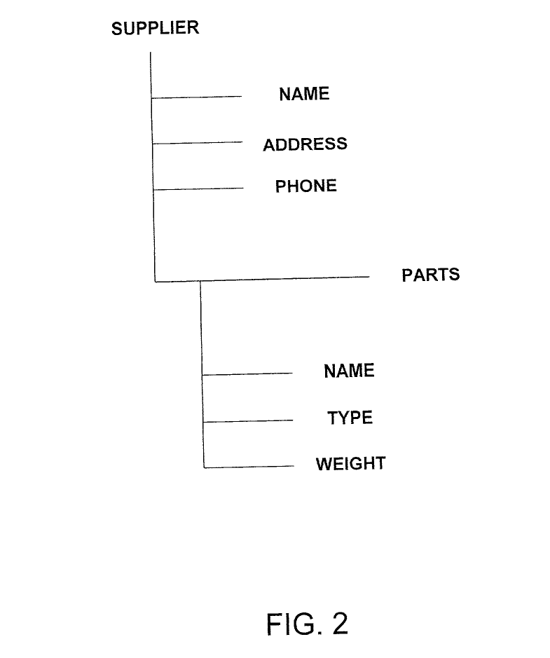

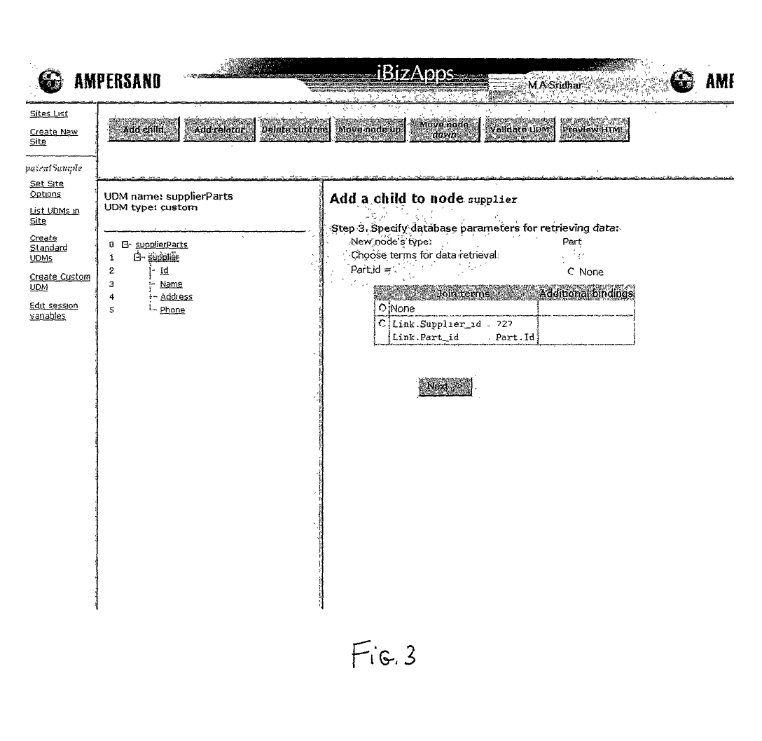

From data schema 102 of FIG. 1, a set of user data models may be specified. In one embodiment, all possible user data model combinations are generated. To automatically generate a user data model, a tree is created with the root node corresponding to a primary database table, and a child node corresponding to a related table. In the example of FIG. 1, the root node is the supplier 104 and the child node is the part 106. Such a tree is shown in FIG. 2. Note that under the root node “Supplier,” all the fields of supplier table 104 are shown under the root node (such as “name” “address” and “phone”). Under the child node “Part”, all the fields of the part table 106 are shown (such as “name,” “type” and “weight”).

At this point, it is possible (at least theoretically) identify every possible user data model that can be constructed from a given schema. Three examples illustrate this. In the first example, there is one model for each table in the database. Such a model includes just the data elements (columns) of the table in question. In the second example, there is one model for each pair of “related” tables. Two tables are deemed “related” if there is a reference from one to the other in the database. In the third example, there is one model for each three “related” tables containing at least one chain of relationships among them.

Larger numbers of related tables may be analyzed similarly. However, the number of possible models soon becomes very large. The database schema may be viewed as a graph whose nodes are tables and whose edges are relationships between tables. This perspective facilitates the application of standard graphtheoretic algorithms for enumerating the data models as well as for generating the back-end code.

To illustrate the mechanism of constructing the Java and SQL code for handling backend logic, the supplier-parts data schema may be employed as a running example. Each database table is represented by a Java class, and an instance of such a class contains a record of the table. In addition, a second Java class encapsulates the database logic and the SQL code.

For a single table, the SQL code for retrieving, storing and modifying the data in the table can be automatically created and embedded into the Java classes. For instance, for the above supplier-parts example, the code below shows parts of the Java classes corresponding to the Part table. Note that reference line numbers have been added to the codes for ease of reference. In the production codes, these reference numbers do not exist.

| | |
|---|---|
| 1 | /** |
| 2 | * Construct an instance of Part from an explicit list of |
| 3 | * parameters. |
| 4 | */ |
| 5 | public Part |
| 6 | ( |

| | |
|---|---|
| 7 | int Id |
| 8 | , java.lang.String Part_number |
| 9 | , java.lang.String Name |
| 10 | , int weight |

| | |
|---|---|
| 11 | ) { |

| | |
|---|---|
| 12 | _valueHash = new Hashtable(); |
| 13 | |
| 14 | _valueHash.put (“Id”, new Integer (Id)); |
| 15 | _valueHash.put (“Part_number”, Part_number); |
| 16 | _valueHash.put (“Name”, Name); |
| 17 | _valueHash.put (“weight”, new Integer (weight)); |

| | |
|---|---|
| 18 | } |
| 19 | public Vector getObjects |

| | |
|---|---|
| 20 | (String whereClause, String otherTableNames, DbConnection |
| 21 | connection) throws SQLException { |
| 22 | String fieldString = “” |
| 23 | |

| | |
|---|---|
| 24 | + “ Part.Id” |
| 25 | + “, Part.Part_number” |
| 26 | + “, Part.Name” |
| 27 | + “, Part.weight” |

| | |
|---|---|
| 28 | String fromClause = “Part”; |
| 29 | if(otherTableNames != null && otherTableNames.length() > 0) |
| 30 | fromClause += “, ” + otherTableNames; |
| 31 | String sqlString = “select ” + fieldString + “ from ” + fromClause; |
| 32 | if(whereClause != null && whereClause.length() > 0) |
| 33 | sqlString += “ where ” + whereClause; |
| 34 | QueryResponse q = connection.executeSql (sqlString); |
| 35 | ResultSet r = q.resultSet(); |
| 36 | Vector v = new Vector(); |
| 37 | _seenIdsSet.clear(); |
| 38 | while (r.next()) { |
| 39 | Integer primaryKey = new Integer (DbUtils.getint (r, “Id”)); |
| 40 | if(!_seenIdsSet.contains (primaryKey)) { |
| 41 | v.addElement (buildFromResultSet (r)); |
| 42 | _seenIdsSet.add (primaryKey); |
| 43 | } |
| 44 | } |
| 45 | q.close(); |
| 46 | returnv; |

| | |
|---|---|
| 47 | } |
| 48 | |
| 49 | /** |
| 50 | * Save the given object into the database via the given connection. If |
| 51 | * the object has an id of zero, it is treated as a request to insert a |
| 52 | * new record into its table. Otherwise, this is treated as an update |
| 53 | * request. In either case, this method returns the id of the inserted |
| 54 | * or updated object. |
| 55 | */ |
| 56 | public int saveToDatabase (DbObject object, DbConnection |

connection)

| | |
|---|---|
| 57 | throws java.sql.SQLException { |
| 58 | int id = object.id(); |
| 59 | if(object.id() != 0) { |
| 60 | modifyDatabaseRecord (id, object, connection); |
| 61 | } else { |
| 62 | String sqlString = “insert into Part (” |
| 63 | |

| | |
|---|---|
| 64 | + “Id” |
| 65 | + “,Part_number” |
| 66 | + “,Name” |
| 67 | + “,weight” |
| 68 | + “) values (” |
| 69 | |
| 70 | + “” + |
| 71 | “Part_sq.nextval” |
| 72 | + “,” + DbUtils.sqlRep ((java.lang.String) |

object.valueOfAttribute (“Part_number”))

| | |
|---|---|
| 73 | + “,” + DbUtils.sqlRep ((java.lang.String) |

object.valueOfAttribute (“Name”))

| | |
|---|---|
| 74 | + “,” + DbUtils.sqlRep ((Integer) object.valueOfAttribute |

(“weight”))

| | |
|---|---|
| 75 | + “)”; |

| | |
|---|---|
| 76 | connection.beginTransaction (); |
| 77 | |
| 78 | QueryResponse q = connection.executeSql (sqlString); |
| 79 | q.close(); |
| 80 | |
| 81 | |
| 82 | // Get the id of the newly-inserted record, and set it as the id |
| 83 | // of the object |
| 84 | sqlString = “select Part_sq.currval from dual”; |
| 85 | QueryResponse q1 = connection.executeSql (sqlString); |
| 86 | ResultSet r = q1.resultSet(); |
| 87 | if(r.next()) |
| 88 | object.setId (r.getInt (1)); |
| 89 | connection.commitTransaction (); |
| 90 | q1.close(); |

| | |
|---|---|
| 91 | } |
| 92 | return object.id(); |

| | |
|---|---|
| 93 | } |

1. The code lines 7-10, 14-17, 24-27, 64-67, and 72-74 illustrate places where the generator introduces lists of attribute names corresponding to the actual attributes of the table. Thus the process for constructing the Java classes corresponding to the database tables is as follows. First, analyze the database schema and create a list of tables, and a list of attributes for each table. Thereafter using a pre-created Java class template, create two classes for each table in the list, by replacing occurrences of the table name and list of attributes by the corresponding values. This accounts for both the Java code and the embedded SQL code. Thereafter, outputting the resulting Java classes.

There is created “generic” back-end Java code that relies on the automatically-generated Java classes for correct operation with multi-table userdata models. The code is generic, in that its structure does not rely either on a particular table structure or a particular user data model structure. It merely assumes that the user data model is laid out as a tree, as shown in the earlier diagram. Generally speaking, this code operates as follows:

First, inspect the tree structure of the user data model, and with each non-leaf element of the tree, associate the two Java classes corresponding to the table for which the node is created.

To retrieve data associated with the model, traverse the tree from root to leaf. For each non-leaf node encountered along the way, invoke the data retrieval methods of the corresponding Java classes, and accumulate the results in an internal data structure. Return this data structure when the traversal is complete.

To store data associated with the model, traverse the tree from root to leaf, and insert the associated data into the database. Data storage is complicated by the fact that the foreign-key dependencies in the database are not necessarily consistent with the ordering of data elements in the tree. Consequently, it is desirable to compute, a priori, a topological sort ordering of the tables, so that non-dependent tables occur before dependent tables in the ordering. (Topological sorting is a widely-known algorithm in graph theory, and we have applied it to database schemas.) During data storage, it is desirable that data is inserted in tables according to their order of occurrence in the topological sort ordering.

As indicated earlier, determining the collection of all user data models to be generated is simply a matter of constructing a graph model for the database schema and identifying all 2-table, 3-table (or multi-table) relationships in which there is at least one chain of dependencies among the tables. Determining such table groups is a matter of using a suitable graph algorithm (e.g., breadth-first search). For each such group, construct all the possible user data model trees and present them as possibilities to the user.

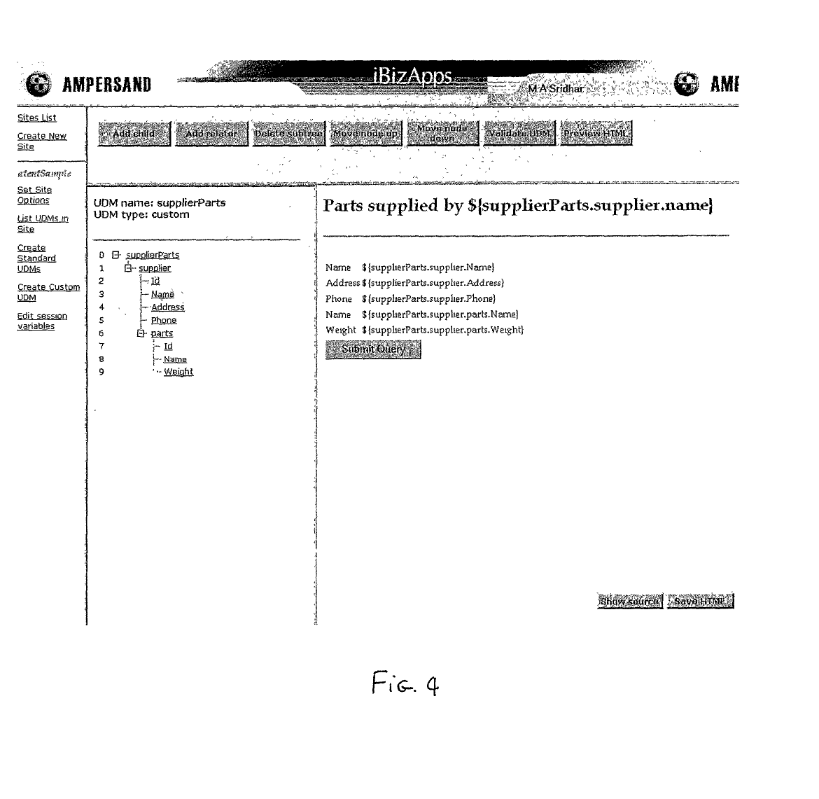

FIG. 3 shows one of the steps in the process of creating a new model. The schema used in creating this model is the same as that of FIG. 1. This particular step is an intermediate step in adding a child named “part” to the node named “supplier”, and highlights the fact that the system has automatically determined the identity of the linking table and therefore the possible “join terms” in the SQL to be generated.

FIG. 4 illustrates a completed user data model tree in the left pane, with the automatically-generated HTML in the right pane.

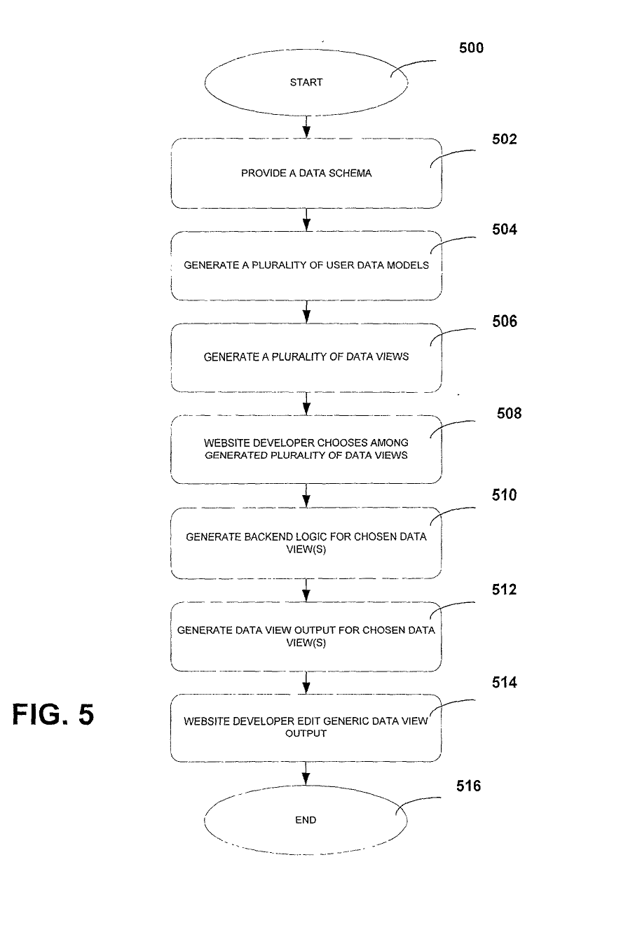

FIG. 5 shows, in accordance with one embodiment, a simplified flowchart illustrating the general steps involved in developing a website. In step 502, a data schema is provided. As mentioned, this data schema represents tables in a relational database from which the user wishes to obtain one or more specific data views in one or more webpages or other output medium. In step 504, a plurality of user data models are automatically generated. In one embodiment, the user data models generated in step 504 represents all possible combinations of data views. Note that as the term is employed herein, automatic generation denotes the fact that the generation of the thing generated is performed using computer-implemented logic instead of using a manual (whether by hand or computer-assisted) method. Automatic generation does not preclude (by also does not require) the possibility that the website developer may issue one or more commands to start the generation of the thing generated.

In step 506, data views are generated from the user data models generated in step 504. In step 508, the website developer chooses from among the data views generated in step 506 one or more desired data views. By way of example, the data views generated in step 506 may be presented in a list form and the website developer merely checks off the desired data views from the list. Once the desired data views are ascertained, links may be inferred from the user data models associated with the desired data views, and the backend logic therefor may be automatically generated (step 510). In step 512, the user interface front-end is generated. In this step, the data view output for a selected data view may be created on one or more generic webpages. Note that although the webpage example is employed herein to simplify the discussion, it should be noted that the data view output may be created (and subsequently modified by the website developer) in any suitable and/or specified user-interface front end. Examples of suitable user-interface front ends include Internet-enabled telephones, Wireless Application Protocol-enabled cellular phones, Internet-enabled handheld computers, Internet-enabled two-way pagers, and the like.

In step 514, the website developer may edit the generic webpage output to conform the data to a desired data presentation format (for example to enhance aesthetics, readability, or user-friendliness).

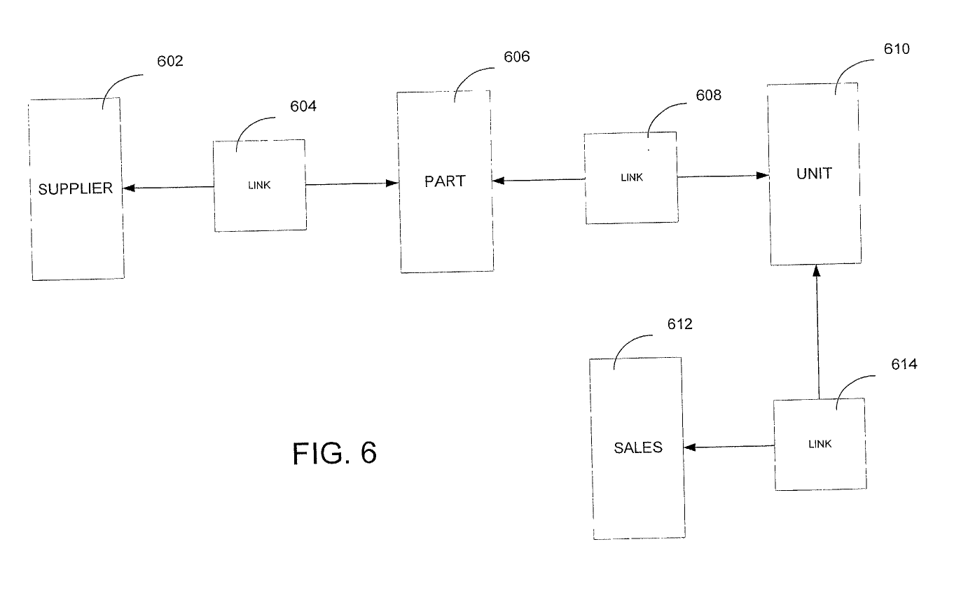

When a more complex data schema is involved and/or where the relationship among multiple tables is complex, it may be desirable to receive the user data model directly from the website developer instead of generating all possible user data models for the website developer to choose. FIG. 6 shows an example of a data schema that involves many interrelated entities. In the example of FIG. 6, one may want to keep track of sales by unit, with each unit having multiple parts and each part supplied by multiple suppliers. If the user desires a view that shows all sales 614 by a particular supplier 602 and also the parts (606) which contributes to the sales. Automatically generating all user data models for the data schema of FIG. 6 may result in a massive list of user data models and data views from which the website developer must search through and select the desired ones. In this case, the provision of an editing tool that allows the website developer to specify the exact user data model associated with the desired data view may be highly useful.

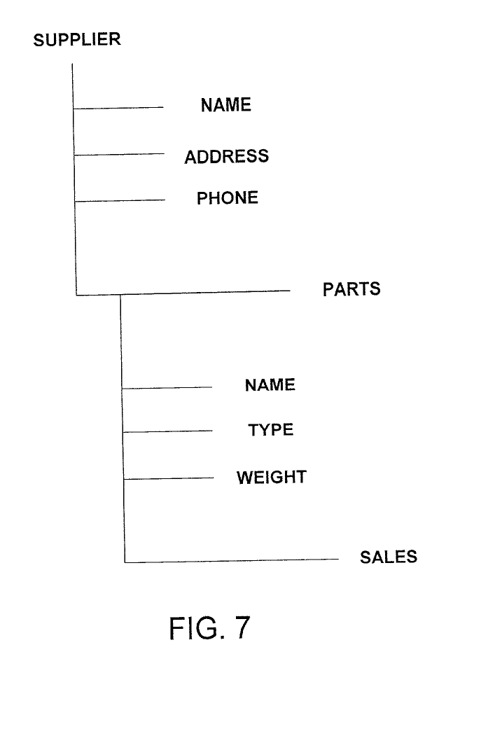

FIG. 7 shows, in one embodiment, an exemplary user data model that supports a more complex data view than that associated with FIG. 2. In FIG. 7, the supplier 702 may be, for example, AC-Delco and the part 704 may be, for example, radios, speakers, cassette decks, and the like. Sales 706 reflects the sales associated with the part 704 from the supplier 702. With a user data model editing tool, the user data model hierarchy of FIG. 7 may be input by the website developer. From the supplied user data model, the system may then automatically infer links to create the backend logic (e.g., the the SQL or Java codes). Thereafter, the user interface front-end is generated for the data view associated with the supplied user data model.

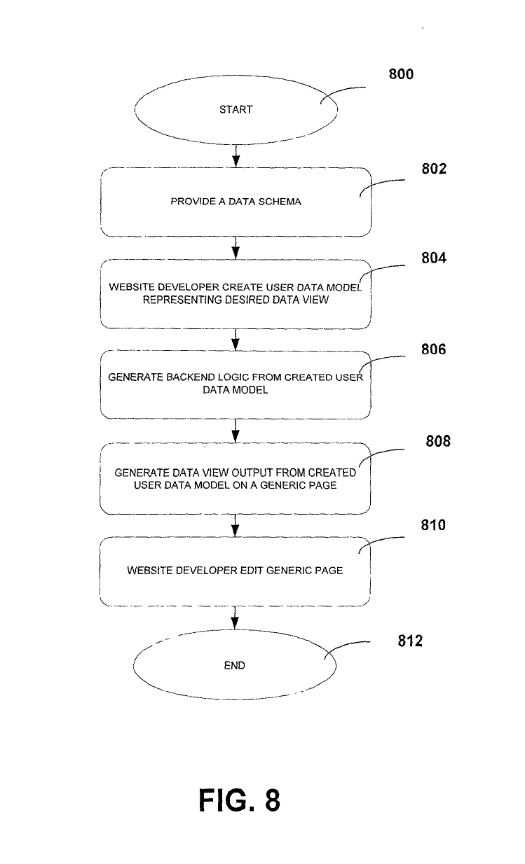

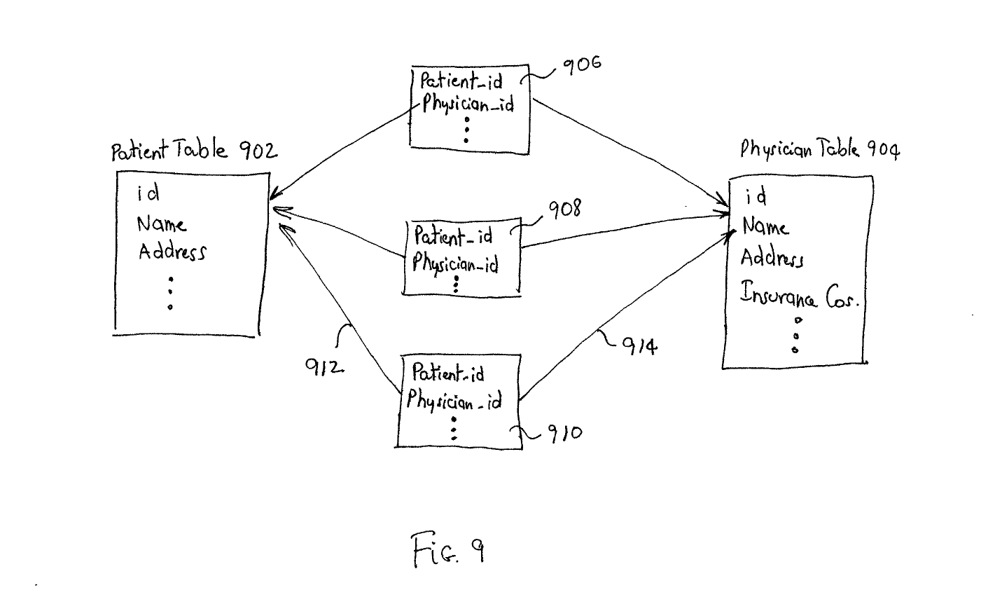

FIG. 8 shows, in accordance with one embodiment, a simplified flowchart illustrating the general steps involved in developing a website having relatively complex data views. In step 802, a data schema is provided. In step 804, the website developer may employ an editing tool to create a user data model that represents the desired eventual data view.

In step 806, links may be inferred from the user data model furnished by the website developer, and the backend logic therefor may be automatically generated. In step 808, the data view output is generated. In this step, the data view output for a data view may be created on one or more generic webpages. In step 810, the website developer may edit the generic webpage output to conform the data to a desired data presentation format (for example to enhance aesthetics, readability, or user-friendliness).

As can be appreciated from the foregoing, the invention facilitates the development of websites without requiring the website developer to have in-depth programming knowledge or sophisticated technical understanding of website development. Even for those having a high level of technical sophistication, the present invention simplifies the website development process in that it essentially reduces website development to a series of choices to be made (e.g., choice of data views in the case where all data views are generated) or simple editing of the user data model that represents the desired eventual data view. The steps in between, i.e., the creation of the backend logic that interfaces with the database and manipulates the data as well as the outputting of the data view output on a user-interface front end, are automatically performed for the website developer. The website developer remaining task is then to beautify the generic data view output to conform to his desired data presentation format.

This is in contrast to the prior art approach wherein the website developer is engaged to write programming codes for each data view desired. Whenever a new data view is desired, new codes must be written and new HTML pages must be coded. In the present invention, the addition of a new data view involves choosing the desired data view from the list of all possible data views and then beautifying the result (in the case of relatively simple data relationship) or specifying the user data model representing the desired eventual data view and then beautifying the result (in the case of more complex data relationship). In either case, the burden on the website developer is substantially lower.

Furthermore, the invention facilitates the creation of a website that is highly decoupled and platform independent. This is in contrast to the platform-dependent, black-box nature of prior art application development tool environments. In the present invention, the backend logic is generated independent of the front-end user interface. The backend logic is preferably generated using a cross-platform language to allow the developed website to be deployed on a wide variety of computers and operating systems, which reduces the possibility of incompatibility with the customers' legacy computing resources and promotes maintainability. The front end user interface is decoupled from the backend logic and is also generated in a language that is also platform-independent (such as HTML or XML).

In accordance with one aspect of the present invention, it is recognized that the complexity and sheer number of possible relationships among records of various data tables in a typical commercial or industrial database present difficulties to website developers when they are trying to come up with the desired user data model. Specifically, the user data model provided by the website developers needs to accurately reflect a subset of all possible relationships between data records and/or data tables of the supplied data schema. If a part of the specified user data model specifies a relationship that is not enabled by the provided data schema, this erroneous specification will prevent the desired data view from being generated. In a highly complex database with a large number of data tables, each of which may have numerous records and fields specifying specific relationships with other records and fields of other data tables, the specification of an accurate user data model is not a trivial exercise for the website developer.

From this recognition, it is realized that website developers need assistance in developing user data models. In particular, website developers can benefit from a tool that allow them to specify user data models in such a way that is both user-friendly and accurate. In accordance with one aspect of the present invention, it is realized that the amount of effort and the chance for error can be reduced if the website developer is furnished, during the user data model specification process, with an automatically extracted list of possible relationships between a given data table under consideration and the data tables with which it is related per the furnished data schema. From these possible relationships, which are automatically extracted from the furnished data schema, the website developer can select the desired relationship as a way to develop the user data model. Thus, the invention serves to both reduce the effort required on the part of the website developer to accurately recognize possible relationships from the supplied data schema (by automatically extracting the possible relationships from the data schema and presenting them to the website developer) and to eliminate error in relationship specification (by limiting the choice to only the list of possible relationships presented). Furthermore, once the desired relationship is selected from the list of possible relationships, the SQL or formal query statements can be automatically generated for the selected desired relationship, thus further reducing the effort required to generate such statements.

Although there are many ways to extract possible desired relationships between data tables, graph theory is employed in a preferred embodiment. Graph theory by itself is not new. In fact, graph theory is a well studied domain and has been around for sometime, although not employed in the manner disclosed herein. By way of example, the references G. Chartrand and L. Lesniak, Graphs and digraphs, Wadsworth, Inc., 1986, S. Even, Graph algorithms, Computer Science Press, 1979, A. Aho, J. Hopcroft and J. Ullman, Design and analysis of computer algorithms. Addison-Wesley, 1974., which are incorporated by reference, may be reviewed for background information regarding graph theory.

In the present invention, graph theory is employed to model the relationships between data tables of the provided data schema and to extract the possible relationships between a data table and its related data tables for use by the website developer during the steps of the user data model specification process. Generally speaking, a graph has at least two main components: a node and a link. In the supplied data schema, data tables are represented by nodes. Links (also edges and/or arcs although the disclosure employs the term “link” generically) may be employed to model the foreign key/primary key relationships between records of a table and records of its related tables. Links may be nondirectional, unidirectional or bidirectional, and may be either weighted or unweighted. Other variations also exist for the links.

After modeling the data schema as a graph, all the nodes and links pertaining to a particular data schema may then be stored in a graph data structure such as an adjacency list or an adjacency matrix. The choice of adjacency list versus adjacency matrix representation is determined by the particular algorithm we wish to execute, since this choice largely determines the run-time efficiency of the algorithm. Additional information pertaining to graph data structures may be obtained from the above references, which are incorporated by reference. During the user data model specification process, an appropriate graph algorithm (such as breadth-first search) can be employed to mine the graph for possible relationships between a particular data table and other data tables of the data schema, and to present those possible relationships to the website developer for selection. Breadth-first search is a standard algorithm which forms the basis for solving many well-known graph problems. After selection is performed, the SQL statements may be generated based on the identity of the nodes/tables selected, as well as the links that are associated with these tables.

To facilitate discussion, FIG. 9 is a logical depiction of the relationships between a patient table 902 and a physician table 904. As can be seen in FIG. 9, at least three relationships are possible between a patient and a physician. To a given patient, a given physician may be a referring physician (logically represented through table 906), a primary physician (logically represented through table 908), or a secondary physician (logically represented through table 910). A patient may have multiple referring or secondary physicians, and thus the actual relationships may be even more complex.

These tables are modeled in the graph as nodes. Further, each table/node (e.g., secondary table 910) has a relationship with a related table/node (e.g., patient table 902 or physician table 904) that is specified by a link (e.g., link 912 or link 914 respectively). In general, the links associated with a given table can be ascertained by examining its foreign key relationships. Recall that a foreign key/primary key pair is the mechanism by which a database designer specifies the relationship between two tables. By way of example, when the secondary table 910 is created during the process of database generation by the database designer, a foreign key may be specified to point to patient table 902 and another foreign key may be specified to point to physician table 904. At each of patient table 902 and physician table 904, there is a corresponding primary key that holds the value referenced by the foreign key in the secondary table 910. These foreign key/primary key relationships are modeled as links in the graph. On the logic depiction of FIG. 9, line 912 represents one such link between the secondary physician table 910 and the patient table 902.

Since link tables (such as referring physician table 906, primary physician table 908, or secondary physician table 910) define the relationships between other tables (such as patient table 902 or physician table 904), a convention needs to be developed to identify whether a particular table in the graph is a link table. In accordance with one aspect of the present invention, a link table is understood to be any table that has two or more foreign keys pointing to other tables. If such a table is encountered, it is understood to be a possible relationship alternative and therefore a possible candidate for selection by the website developer.

With reference to the example of FIG. 9, during the user data model creation process, the three alternative relationships between patient table 902 and physician table 904 may be extracted from the graph and presented to the website developer. From this list of three possible alternative relationships, the website designer may choose one (e.g., secondary). The corresponding portion of the user data model is then created from the chosen relationship and the SQL statements may then be formed. Exemplary SQL statements may be “secondary.patient_id=patient.id” and “secondary.physician_id=physician.id” These SQL equalities reflect the relationships specified by links 912 and 914 in FIG. 9, which links and nodes 902/904 are extracted from the graph employed to model the data schema of FIG. 9.

In accordance with another aspect of the present invention, the graph model of the data schema may be leveraged to help enforce the data integrity aspect of the foreign key dependency. Data integrity in this context refers to the requirement that a data record in the table that contains the foreign key(s) must have a counterpart in the table that contains the primary key(s). Data integrity is relevant, for example, when a record needs to be added to the secondary physician table 910. When a record is added that includes secondary key(s), it is a requirement that there already be a record in the table associated with the primary key(s) so that the foreign keys can refer to valid values. To put it differently, the order in which records are added matters when foreign key/primary key relationships are involved.

In a complex data schema with complex interrelated foreign key/primary key relationships, it is difficult for programmers to keep track of the order by which records need to be added to support data integrity. At the front end, the user is typically unaware or uninterested in the requirements data integrity for all possible foreign key/primary key relationships. Accordingly, a technique needs to be devised to allow records to be inserted into the tables of the data schema in the correct and user-friendly manner.

In accordance with one aspect of the present invention, the same extracted graph can be employed to support the data integrity requirements of the foreign key/primary key relationships. More specifically, a topological sort may be employed on the graph to extract a map, which represents the ordering of tables according to their foreign key/primary key relationships. Topological sort is well known and additional information may be obtained from references such as the references by Aho, Hopcroft and Ullman listed above, which is incorporated by reference herein.

This map may be incorporated with the business logic that is responsible for record insertion such that the tables associated with the primary keys are always handled prior to the tables associated with the secondary keys for any given foreign key/primary key relationship. One way to employ the map is to provide a numbering scheme that associate a priority number with each table such that the table(s) with the higher priority numbers are associated with the primary keys and are handled first before the tables with the lower priority numbers (which are associated with the secondary keys) are handled. Thus, records may now be inserted in any order, and at the backend, they will be handled in the appropriate manner to satisfy the requirements of data integrity.

To further discuss the use of topological sorting, consider the example of FIG. 9. Because of the foreign key constraints among the tables, it is important that a record be inserted into the table 906 (linking patient and physician, representing the “referring physician” relationship) only after corresponding records have been inserted into (or are already available in) the patient and physician tables 902 and 904 respectively. When a topological sort order is constructed, it assigns a numerical ranking, or “priority,” to each table, such that inserts into a higher priority table must precede those into a lower priority table. One of the possible rankings in this example would be to assign the ranks 10 and 9 for the patient and physician tables(902 and 904 respectively), and the ranks 8, 7 and 6 to the three linking tables (906, 908 and 910). When the user of the website requests to insert data into these three tables, he does not need to specify the order of insertion. The back-end logic, however, first consults the pre-constructed ordering, determines that the patient and physician tables have higher priority, and (correctly) inserts into those tables before inserting into the linking table.

The graph model of the data schema can also be leveraged to detect the presence of loop errors. A loop error occurs when an entity refers to itself indirectly in the database (i.e., a circular reference) and is almost always an error in the definition of the data schema. In a large, complex database, manual detection of loop errors is very difficult and tedious, and many loop errors may escape the manual detection process to wreak havoc after product release. In accordance with another aspect of the present invention, once the data schema is modeled by nodes and links of the graph, a cycle detection algorithm may be employed to detect loops in the graph. This is another innovative application of the graph theory to the data schema. Exemplary loop detection algorithms applicable to graphs for this purpose include depth-first traversal, breadth-first traversal, and the computation of biconnected components, and details pertaining thereto may be found in the references listed above, which are incorporated by reference.

In accordance with another aspect of the present invention, there is provided a computer-implemented method for automatically dereferencing the content of a link table so as to present the content of the link table in a more readily understandable manner to either the website developer or the end user. As mentioned earlier, a link table specifies relationships among attributes of other tables of the database. In constructing the schema for the database, the database designer already devoted a great deal of attention and thoughts to the data elements and their relationships. By way of example, the database designer may designate certain tables to fulfill the role of link tables (by virtue of their foreign key relationships with the primary keys of other tables). These relationships are captured, in the context of the invention herein, in the link tables.

However, such relationships are typically not readily perceptible to the website developers since data fields in records of the link tables are represented, as is known to those familiar in the relational database art, by the record IDs of the records in the related tables. While such representation is efficient from the standpoint of the relational database management system, it is far from being user-friendly to human users. Accordingly, the full benefit of the extensive thought process and efforts of the database designer is often denied to the website developer, who must build the web site in view of the supplied data schema of the database.

In the past, dereferencing the content of a link table typically requires custom programming. In a typical case, a custom program is written for a specific link table after the underlying relationships between the foreign keys of the link table and the primary keys of the related tables are understood. The custom program dereferences the cryptic record ID number contained in the data fields of the data records of the link table. Thus, theoretically speaking, it is possible to dereference the content of link tables via custom programs. In practice, however, dereferencing of link tables via custom programs is typically performed, if at all, on a very limited basis since custom programming is expensive and time consuming. Accordingly, there is a need for a computer-implemented method for automatically dereferencing the content of link tables which avoids the expense and time-consuming aspects of the custom programming approach.

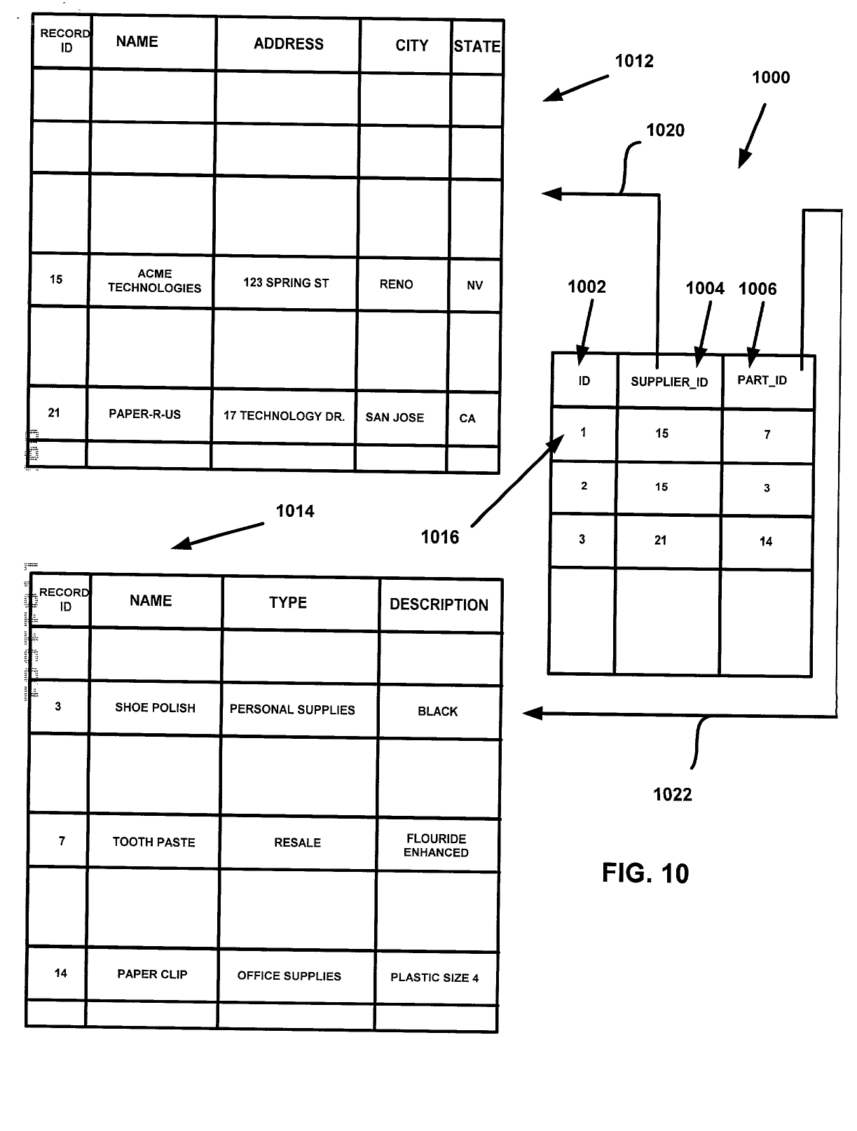

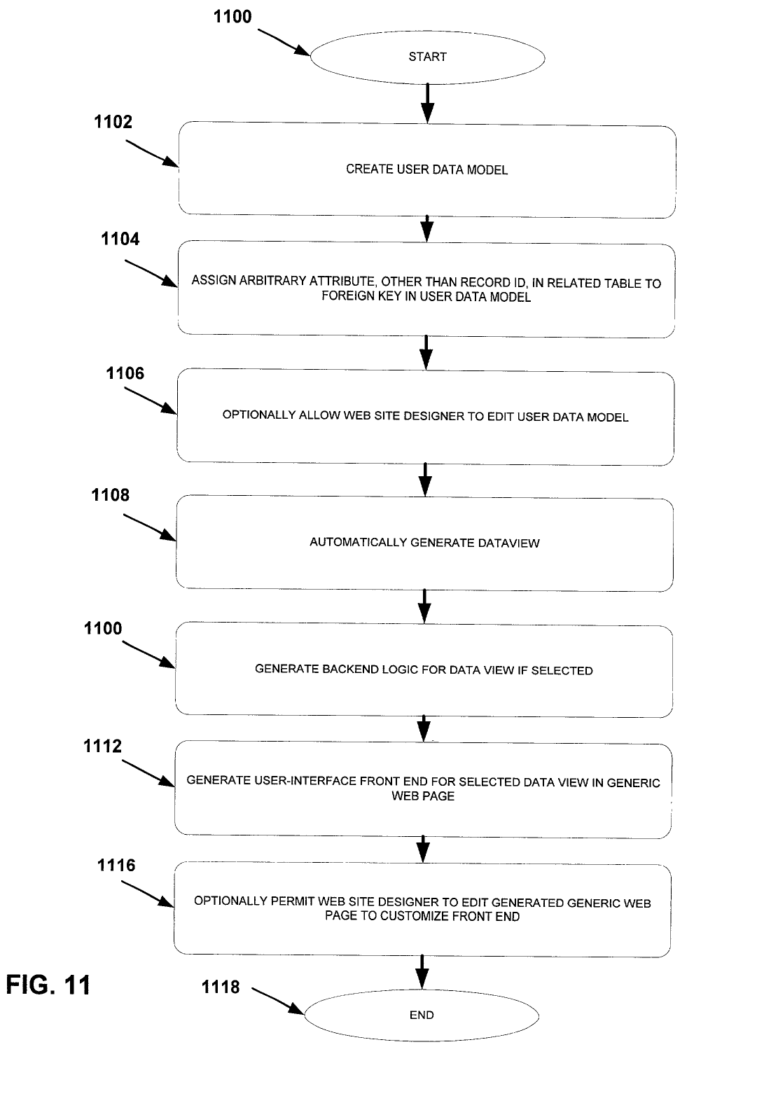

Details of the automatic dereferencing aspect of the present invention may be better understood with reference to the figures that follow. In FIG. 10, a simple link table 1000 is shown having three attributes: a RecordID attribute (1002), a Supplier_ID attribute (1004) and Part_ID attribute (1006). In the example of FIG. 10, the Supplier_ID attribute 1004 is a foreign key attribute that indicates a relationship between link table 1000 with Supplier table 1012. The Part_ID attribute 1006 is likewise a foreign key attribute that indicates a relationship between link table 1000 with Part table 1014. Each record of link table 1000 is also assigned a record ID number, which is represented by the attribute recordID.

A certain link record of link table 1000, such as the record with the RecordID =1 (indicated by reference number 1016 in FIG. 10) thus indicates a relationship between a particular supplier with a particular part and may be employed to ascertain, for example, the parts that a particular supplier supplies or the suppliers that supply a particular part. As shown in FIG. 10, the data fields corresponding to both the Supplier_ID attribute and the Part_ID attribute are represented in each record of link table 1000 by numerical values which correspond to the record numbers in the related tables. For the record whose RecordID=1 (reference number 1016 in FIG. 10), the Supplier_ID attribute field has a value of 15 and the Part_ID attribute field has a value of 7. Thus, this link record indicates that the part contained in record #7 of part table 1014 is supplied by the supplier identified in record #15 of supplier table 1012.

If a website developer were to look at link table 1000 in isolation, little information regarding the relationships between attributes of supplier table 1012 and part table 1014 could be ascertained. To most website developers, the number 15 in the Supplier_ID attribute field of link record #1 and the number 7 in the Part_ID attribute field of link record #1 mean little. If the content of link table 1000 could be automatically dereferenced using a computer-implemented method, the relationships between these data entities, which relationships were carefully thought out by the database designer, would be more understandable to the website developer and be more useful to the website developer in the task of manipulating the data and presenting the result to the end user. Furthermore, the speed and relatively low cost of a computer-implemented method for automatically dereferencing link tables would render the possibility of dereferencing link tables for the use by the website developer a more practical proposition, from both time and cost perspectives.

One of the difficulties of automatically dereferencing the content of the link table is to ascertain which attribute of the related table (such as supplier table 1012) a particular foreign key refers to. In the example of FIG. 10, although the value 15 in the Supplier_ID attribute field of link record #1 (reference number 1016 in FIG. 10) indicates a relationship with the record #15 in supplier table 1012, it is unclear looking at link table 1000 which particular attribute (name, address, city, or state) of supplier table 1012 would be relevant. Indeed, the information required to ascertain which attribute of the related table a particular foreign key refers to is not encapsulated within link table 1000.

In one embodiment of the present invention, the computer-implemented method simply arbitrarily assigns one of the attributes of the related table (e.g., supplier table 1012 of FIG. 10) to the foreign key attribute in the link table (e.g., link table 1000). In one specific embodiment, the computer-implemented method assigns the first attribute that follows after the recordID attribute in the related table to the foreign key attribute. With reference to FIG. 10, since the attribute “name” is the first attribute that follows after the recordID atribute in supplier table 1012, this attribute “name” in supplier table 1012 is initially assigned to foreign key attribute 1004 (“Supplier_ID”) of link table 1000. Likewise, the first attribute that follows the recordID attribute in the part table 1014 is assigned to Part_ID attribute 1006 of link table 1000. Thus, the attribute “name” of part table 1014 is assigned to Part_ID attribute 1006 of link table 1000.

These assignments result in the dereferencing of the values of the foreign key attributes in the records of the link table. Thus, in the link record #1, the value 15 in the foreign key attribute field Supplier_ID is dereferenced to be the name field of record #15 of supplier table 1012, or “Acme Technologies” in the example of FIG. 10. Likewise, the value 7 in the foreign key attribute Part_ID is dereferenced to be the name field of record #7 of part table 1014, or “toothpaste” in the example of FIG. 10. Other records of link table 1000 are similarly dereferenced.

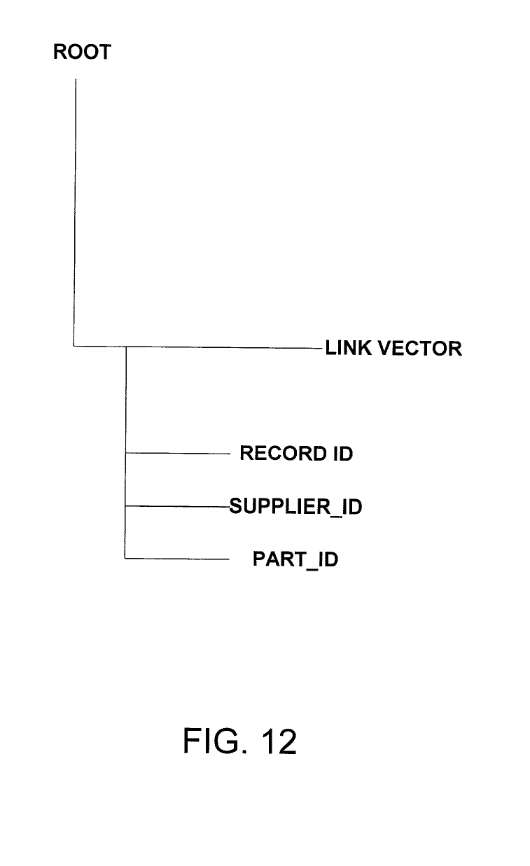

The steps of the computer-implemented method to dereference the content of a link table are shown in FIG. 11. In step 1102, a user data model is automatically generated for the link table. In one embodiment, the user data model is automatically generated by patterning it after a pre-selected user data model, with the link table represented as a child vector nodes and its foreign key attributes represented as attributes of the child vector node. An exemplary user data model for the example of FIG. 10 is shown in FIG. 12.

The general process involved in automatically generating a user data model from a table of the relational database is similar to the general process described earlier in connection with the steps for automating the development of a website. On the other hand, the user data model for the link table may also be created by the website developer using the user data model editing tool.

Once the initial user data model is created, automatic dereferencing of the foreign key attributes in the initial user data model takes place. As shown in step 1104, an arbitrarily chosen attribute in the related table is assigned to the foreign key attribute that points to that related table. In general, this arbitrarily chosen attribute is different from the record ID number attribute associated with each record of the related table. In one embodiment, this arbitrarily chosen attribute is the first attribute in the related table that comes after the record ID number attribute in the related table. This assignment process essentially dereferences the foreign key attribute in the initial user data model.

In step 1106, an optional user data model editing step is shown. In this step, the user data model dereferenced in step 1104 is presented to the website developer. Through the use of a user data model editing tool, the website developer may edit the dereferenced attribute to override the arbitrary assignment done earlier in step 1104 with a more appropriate choice of attribute or attributes from the related table. By way of example, the user data model editing tool may provide a drop-down list for each of the dereferenced foreign key attribute, which drop-down list contains the other attribute choices in the related table for the website developer to choose. If the website developer chooses more than one attribute, syntax rules tools or formatting tools may be provided to facilitate the construction of a compound dereferenced string structure. In one example, the website developer may designate that the dereferenced string structure for the foreign key attribute Supplier_ID include the name of the supplier, to be followed by the supplier's street address, a comma (a formatting structure), the city where the supplier is located, another comma, and the state in all capital letters.

After the user data model is created (and optionally edited by the website developer), a data view is generated for the user data model. This data view, along with all other generated data views associated with other link tables, may then be presented to the website developer for selection (step 1108). If a particular data view is selected, the links therefor may be inferred from the user data model associated with the selected data view and the backend logic is automatically generated (step 1110). The process associated with generating the backend logic for a selected user data model is similar to the process described earlier in connection with, for example, step 510 of FIG. 5. In step 1112, the user interface front-end is automatically generated. In this step, the data view output for a selected data view may be automatically generated on a generic webpage. Thereafter, the website developer may edit the generic web page as appropriate to create the desired web page look (step 1114).

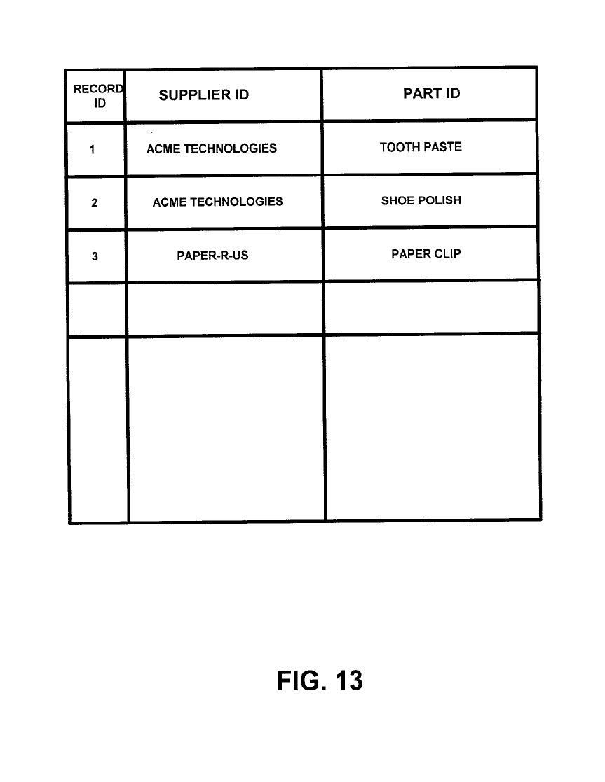

FIG. 13 shows the dereferenced version of link table 1000 of FIG. 10. In the example of FIG. 13, the dereferenced content of link table 1000 is shown simply as a matrix with the original foreign key attributes across the top row, with each link record occupying a row in the matrix. The dereferenced string structure in each row is shown under the associated foreign key attribute column.

As can be appreciated from the foregoing, the invention facilitates automatic generation of dereferenced link tables from the data schema supplied. This automatic generation is made possible by leveraging on the user data model paradigm and the earlier discussed techniques for automatic user data model generation, for initial arbitrary dereferencing of the initial user data model, and for automatic generation of backend logic and front end user interface for the selected user data model. Since the generation of the dereferenced link tables showing its contents and the relationships between attributes of the related tables occurs automatically, the costs in terms of time and expense associated with deriving the content of the link tables and presenting them in an intuitive manner to the website developer so that the website developer can more intelligently leverage on the thought process of and structure created by the database designer is substantially minimized.

In accordance with another aspect of the present invention, the foreign key from a link table to a primary table may advantageously be exploited to provide a simple and automatic way for users to drill down from a record in that primary table to obtain more detailed information contained in the link table. This aspect of the present may be better understood with the example below.

Referring back to FIG. 10, primary Supplier table 1012 is shown linked to Part table 1014 via Supplier-Part link table 1000. In connection with FIGS. 10-13, Supplier-Part link table 1000 is dereferenced by exploiting the relationship information (embodied in the foreign keys) between the link table and the primary tables linked to it. Such dereferencing resolves the content of the link table for the benefit of the website developer and/or user as discussed earlier. There are, however, times when it is desirable to permit viewing and ascertaining, directly from a page view of the content of a primary table, the number of records and/or list of records in the other primary table that relate to a particular record in the primary table under consideration.

To further elaborate, suppose a particular user would like to understand how many records relate to record #15 (“Acme Technologies”) in Supplier table 1012, or to obtain the list of records in the Part table 1014 that relates to record #15 (“Acme Technologies”) in Supplier table 1012. By way of example, a user may wish to obtain the answers to questions such as “how many parts does Acme Technologies supply?” or “what is the list of parts that Acme Technologies supply?”

In the past, the answers to such questions often involve custom programming to create a custom program to analyze Supplier-Part link table 1000. However, such a custom programming approach does not fully exploit the foreign key relationships already present in the database and thus involves unnecessary additional work, time, and/or expenses.

In accordance with one embodiment of the present invention, it is recognized that there already existed in the database specification, which is input by the database designer at the time the database is set up, information pertaining to foreign key relationships between tables. With reference to the example of FIG. 10, the database designer may indicate, at the time the database is designed, that there is a foreign key relationship between Supplier-Part link table 1000 and Supplier table 1012 using a standard database language such as SQL (Structured Query Language). An exemplary SQL structure for the example of FIG. 10 may be as follows:

```
ALTER TABLE Invoice ADD CONSTRAINT RefSupplier3
  FOREIGN KEY (Supplier_id)
  REFERENCES Supplier (Id);
ALTER TABLE Supplier ADD CONSTRAINT RefCategory1
  FOREIGN KEY (Category_id)
  REFERENCES Category (Id);
ALTER TABLE Supplier_part_link ADD CONSTRAINT RefSupplier4
  FOREIGN KEY (Supplier_id)
  REFERENCES Supplier(Id);
ALTER TABLE Supplier_part_link ADD CONSTRAINT RefPart5
  FOREIGN KEY (Part_id)
  REFERENCES Part (Id);
```

In FIG. 10, this specification is represented by arrow 1020. For a particular primary table such as Supplier table 1012, it is recognized that the existence of foreign keys that link to it, as well as the tables from which the foreign keys originate, may be readily determined by examining the database specifications of the various tables and determining whether those other tables have such a foreign key reference to Supplier table 1012. This determination may be made at, for example, build time.

At run time, executable code (e.g., Java code, specification available from Sun Microsystems, Inc. of Mountain View, Calif.), may be created automatically and employed to determine from Supplier-Part link table 1000 the number or list of parts that references a particular Supplier_ID in Supplier table 1012. By way of example, Java codes may be automatically generated and employed to determine how many records in Supplier-Part link table 1000 references record #15 (“Acme Technologies”) and/or to compile a list of those records if desired. Although Java is mentioned as a preferred executable code language, it should be noted that such is not a limitation and other suitable executable codes may also be employed.

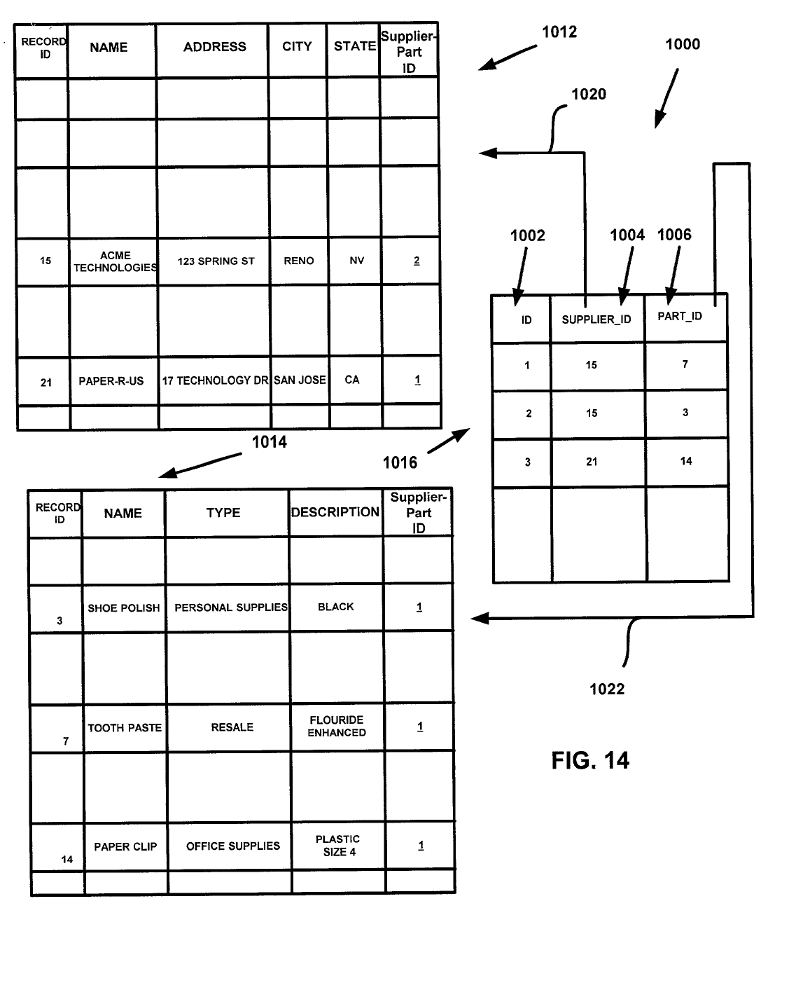

In one embodiment, the reverse referencing of foreign keys is manifested to the viewer by an automatically created additional column in the list view of the primary table (e.g., Supplier table 1012). With reference to FIG. 14, Supplier table 1012 is shown with an additional column “Supplier-Part ID”, which shows associated with each given record in Supplier table 1012 the number of records in Supplier-Part link table 1000 referring to that given record in Supplier table 1012. By way of example, the column Supplier-Part ID in Supplier table 1012 shows that Supplier #15 (“Acme-Technologies”) has 2 records in Supplier-Part link table 1000 referring to it. These two records are shown in FIG. 14 by records #1 and #2 in Supplier-Part link table 1000, which list #15 as the Supplier_ID.

In a preferred embodiment, the values provided by the additional column that implements the reverse referencing of foreign keys are preferably hyperlinks which may be acted upon by the user to obtain further information about records that underlie those values. With reference to FIG. 14, the value 2 associated with record #15 in Supplier table 1012 under the column “Supplier-Part ID” is preferably implemented as a hyperlink in the list view of Supplier table 1012 (and thus shown as an underlined number “2” in FIG. 14). This hyperlink may be automatically generated using, for example, HTML.

When the user activates the hyperlink (e.g., by clicking on it), another underlying page may be presented to furnish a list of records in Part table 1014 that actually corresponds to that foreign key value (e.g., record #15 in this example) in Supplier table 1012. The correspondence information is obtained from the link table that links Supplier table 1012 with Part table 1014, i.e., in Supplier-Part link table 1000. Such underlying page view may be automatically generated using, for example, HTML or XML and executable code (e.g., Java), and may represent a page that permits the browsing of records in the link table by the master table attribute under consideration. This page may be generated based on a preconfigured template, for example. In the example of FIG. 14, the activation of the hyperlink “2” allows a page that permits browsing of parts by supplied by supplier “Acme Technologies” to be presented. If so configured, this page view of parts by supplier “Acme Technologies” may in turn contain other columns that shows values dereferenced from foreign keys that reference the parts shown in the newly displayed page view.

In one embodiment, it is recognized that a given table (such as Supplier table 1012) may have multiple link tables with foreign keys referenced to it. By way of example, there may be a Supplier-Invoice link table that shows the relationship between the suppliers and the invoices received from those suppliers over time. In accordance with one aspect of the present invention, when there are multiple link tables to a given primary table, multiple additional columns may be added to the list view of the primary table, with each column representing the reverse foreign key resolution for one link table.

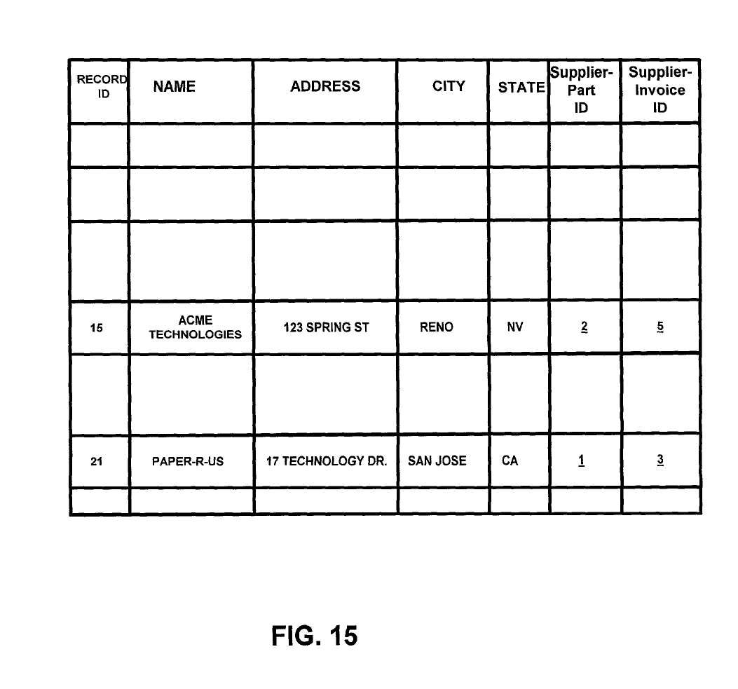

FIG. 15 illustrates, in accordance with one embodiment of the invention, this aspect. In FIG. 15, the presence of two additional columns “Supplier-Part ID” and “Supplier-Invoice ID” indicate that there are two foreign keys to Supplier table 1012. The list view of Supplier table 1012, as shown in FIG. 15, allows a user to obtain greater details pertaining to the 2 parts supplied by Acme Technologies or the 5 invoices already submitted by it (as these values have underlying hyperlink automatically created). Likewise, the view of the list view of Supplier table 1012 may activate the hyperlinks associated with Supplier Paper-R-Us to access detailed information pertaining to the 1 part supplied by Paper-R-Us or the 3 invoices already submitted by Paper-R-Us.

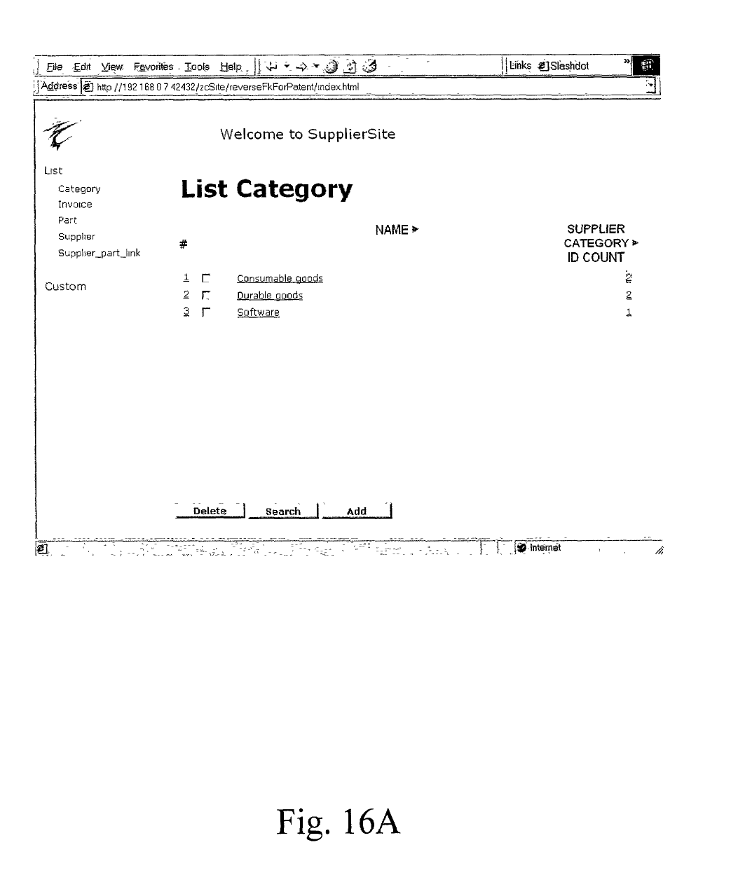

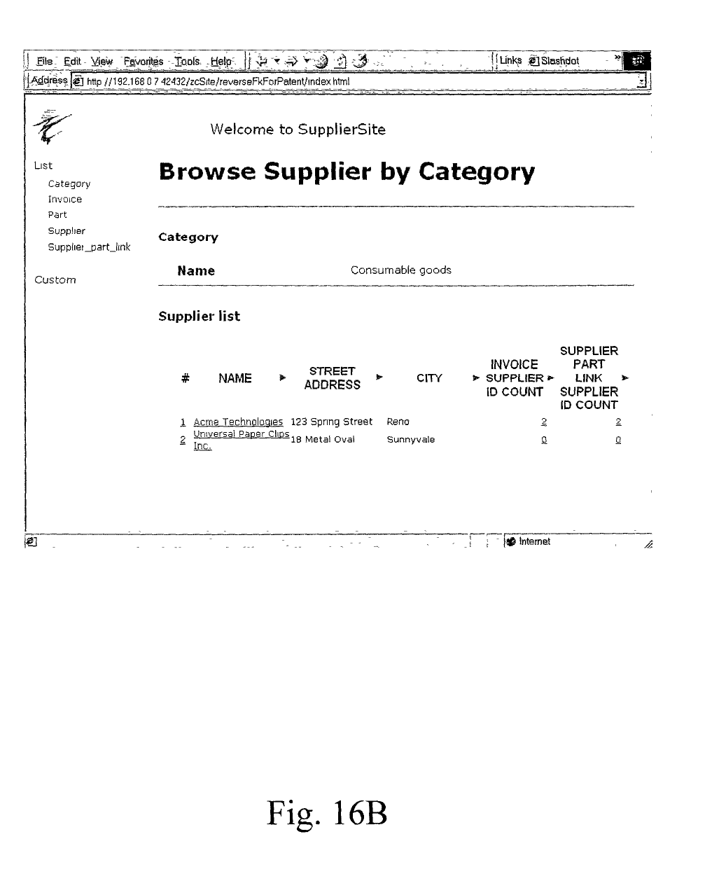

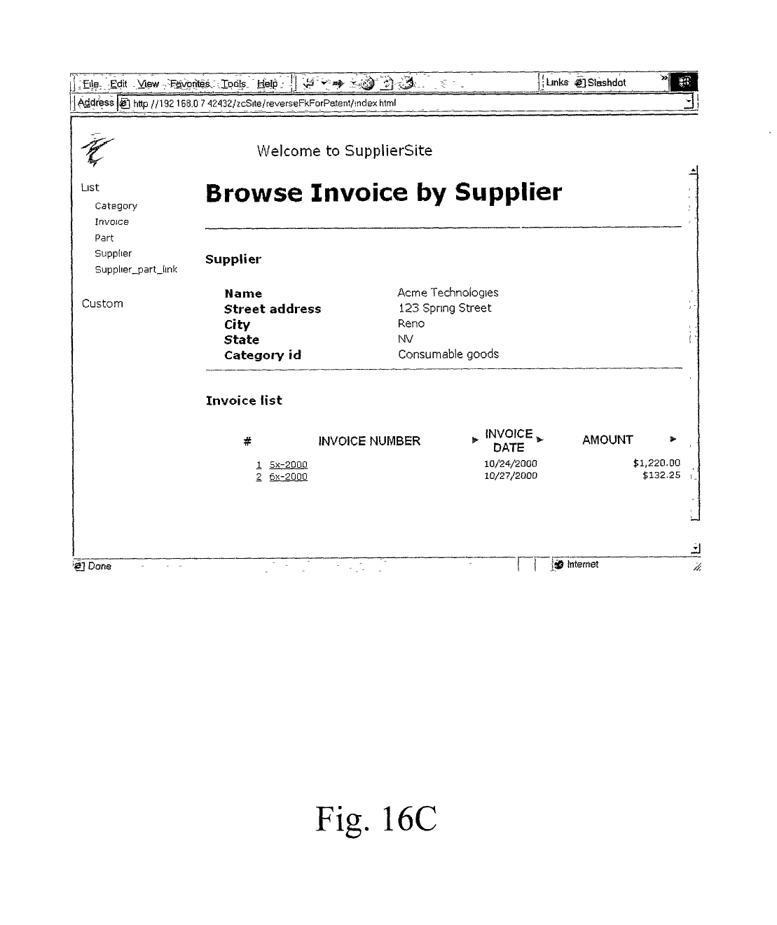

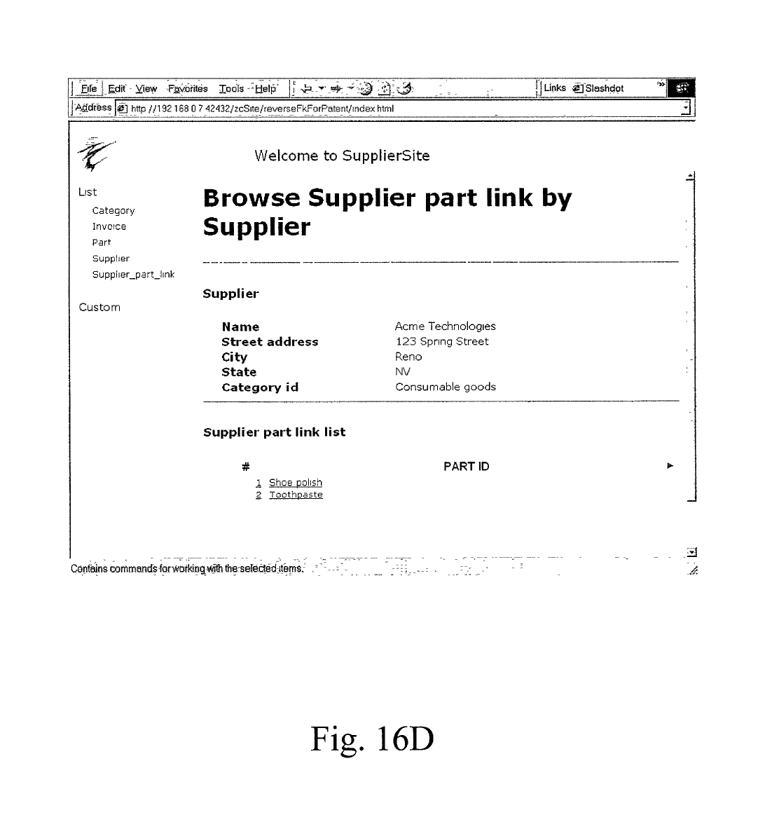

These aspects of the present invention may be better understood with reference to the examples of FIGS. 16A-16D. In FIG. 16A, a list view showing the categories supplied in the SupplierSite is shown, along with a column labeled “SUPPLIER CATEGORY ID COUNT”. This column shows associated with each record in the category table the number of records in the supplier table referring to each such record in the category table. Thus, the category “Consumable Goods” is shown referred by two suppliers (as manifested by the value 2 associated with the record “Consumable Goods.” Note that this value 2 is generated at run time by executable codes based on the determination made at build time regarding the existence of foreign key references to the Category table.

In the example of FIG. 16A, the values in the column labeled “SUPPLIER CATEGORY ID COUNT” are hyperlinks. Activating a hyperlink in this column, such as the value 2 associated with the record “Consumable Goods” will cause the list of suppliers supplying the category “Consumable Goods” to be displayed in a page view. This is shown in FIG. 16B.

Note that in the page view of FIG. 16B, the foreign keys to the Supplier IDs are also dereferenced to show that there are two invoices associated with the record Acme Technologies (as shown by the hyperlinked value “2” in the INVOICE SUPPLIER ID COUNT column) and two parts supplied by Acme Technologies (as shown by the hyperlinked value “2” in the SUPPLIER PART LINK SUPPLIER ID COUNT column). Activating the hyperlinked value “2” associated with the record Acme Technologies under the INVOICE SUPPLIER ID COUNT column causes another page view to be displayed, showing the details of the two invoices for Acme Technologies. This page view is shown in FIG. 16C. Likewise, activating the hyperlinked value “2” associated with the record Acme Technologies under the SUPPLIER PART LINK SUPPLIER ID COUNT column causes another page view to be displayed, showing the details of the two parts supplied by Acme Technologies. This page view is shown in FIG. 16D.

As can be appreciated from the foregoing, the ability to exploit the reverse foreign key reference facilitates the automatic creation of drill-down hyperlinks and access to underlying information, which allow the user to query information along the lines of thought of the database designer. Once the database designer specifies the foreign key relationship between two tables in the database, this relationship may be automatically ascertained (e.g., by search for the appropriate SQL command as discussed earlier) at build time. The relationship is then exploited at run time to create the list views presented to the user (e.g., the list view of the primary table, which includes the additional column showing the reverse foreign key referencing to permit the user, if desired, to activate the hyperlink which brings up the details of the records that references a record in the list view via foreign. The same technique applies for both automatically generated UDMs and user-specified UDMs. Since the hyperlinks, list views, page views and executable codes for obtaining detailed information from the link page are automatically generated, it is possible to furnish this capability anytime the database designer has specified a foreign key relationship between two tables without the expenses and delays associated with custom programming techniques.

While this invention has been described in terms of several preferred embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for automatically presenting relationship information between a first table and a second table of a database, comprising:
ascertaining an existence of a first foreign key relationship between said first table and said second table;
if said first foreign key relationship between said first table and said second table exists, automatically generating first executable codes to obtain, for a first given record in said first table, a first number of records in said second table that references said first given record; and
when said first given record is displayed in a view, also displaying said first number of records in said second table that references said first given record.

2. The computer-implemented method of claim 1 wherein said first number of records in said second table that references said first given record is implemented as a hyperlink.

3. The computer-implemented method of claim 1 further comprising:
upon detecting an activation of said hyperlink, perform the following steps:
a) ascertaining from a third table detailed information pertaining to a first plurality of records, said first plurality of records representing records that, according to said second table, are associated with said first given record; and
b) displaying said detailed information.

4. The computer-implemented method of claim 3 further comprising:
ascertaining an existence of a second foreign key relationship between said third table and another table of said database;
if said second foreign key relationship exists, automatically generating second executable codes to obtain, for a second given record in said third table, a second number of records in said another table that references said second given record; and
when said second given record is displayed, also displaying said second number of records in said another table that references said second given record.

5. The computer-implemented method of claim 4 wherein said second number of records in said another table that references said second given record is implemented as a hyperlink.

6. The computer-implemented method of claim 4 further comprising:
ascertaining an existence of a third foreign key relationship between said third table and a fourth table of said database;
if said third foreign key relationship exists, automatically generating third executable codes to obtain, for said second given record in said third table, a third number of records in said fourth table that references said second given record; and
when said second given record is displayed, also displaying said third number of records in said fourth table that references said second given record.

7. The computer-implemented method of claim 6 wherein said second number of records and said third number of records are displayed in two separate columns when said second given record is displayed.
